(19) United States
(12) Patent Application Publication
(10) Pub. No.: US 2019/0046817 A1
(43) Pub. Date: Feb. 14, 2019

(54) FULL FACE PIECE OF A BREATHING APPARATUS

(71) Applicant: SHIGEMATSU WORKS CO., LTD., Tokyo (JP)

(72) Inventors: Nobuo Shigematsu, Tokyo (JP); Kenichi Ono, Saitama (JP)

(21) Appl. No.: 16/076,434

(22) PCT Filed: Feb. 10, 2016
(86) PCT No.: PCT/JP2016/053887

§ 371 Date: Aug. 8, 2018

(51) Int. Cl. A62B 18/02; A62B 18/10

(52) U.S. Cl. CPC A62B 18/02; A62B 7/00; A62B 18/10

(57) ABSTRACT

[Object of the Invention] An object of the present invention is to provide a full face piece of a breathing apparatus provided with an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material, and wherein man-hours required to manufacture a metal mold for manufacturing the eyepiece are fewer than in the case of the conventional full face piece.

[Disclosure of the Invention] A full face piece of a breathing apparatus is provided with an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material, and wherein the eyepiece comprises a plurality of spherical surfaces.

### TECHNICAL FIELD

The present invention relates to a full face piece of a breathing apparatus.

### BACKGROUND ART

Patent documents 1 and 2 each discloses a full face piece of a breathing apparatus comprising an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material.

### PATENT DOCUMENT

Patent Document No. 1: Japanese Patent Laid-Open No. 2013-085845

Patent Document No. 2: Japanese Patent Laid-Open No. 2013-172779

### DISCLOSURE OF INVENTION

### Problem to be Solved

A conventional full face piece has a disadvantage in that the eyepiece whereof generally exhibits a complicated curved surface that increases man-hours required to manufacture a metal mold for manufacturing the eyepiece.

An object of the present invention is to provide a full face piece of a breathing apparatus provided with an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material, and wherein man-hours required to manufacture a metal mold for manufacturing the eyepiece are fewer than in the case of the conventional full face piece.

### Means for Achieving the Object

In accordance with the present invention, there is provided a full face piece of a breathing apparatus comprising an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material, and wherein the eyepiece comprises a plurality of spherical surfaces.

When the eyepiece comprises a spherical surface, man-hours required to manufacture a metal mold for manufacturing the eyepiece becomes fewer than in the case of the conventional full face piece wherein the eyepiece generally exhibits a complicated curved surface.

When the whole body of the eyepiece exhibits a single spherical surface, decrease of man-hours required to manufacture a metal mold for manufacturing the eyepiece becomes maximum. However, height, breadth and depth of the eyepiece become large and the full face piece or the breathing apparatus comprising the full face piece becomes inconvenient. When the eyepiece comprises a plurality of spherical surfaces, man-hours required to manufacture a metal mold for manufacturing the eyepiece becomes fewer than in the case of the conventional full face piece, while increase of size of the eyepiece can be restrained.

In accordance with a preferred aspect of the present invention, an upper front part and a lower front part of the eyepiece exhibit spherical surfaces independent of each other, and relation between radius of curvature R1 of the upper front part and radius of curvature R2 of the lower front part is defined as R1>R2.

When an upper front part and a lower front part of the eyepiece exhibit spherical surfaces independent of each other, depth of the eyepiece becomes less than that of an eyepiece whose upper front part and lower front part exhibit a single spherical surface. When relation between radius of curvature R1 of the spherical upper front part and radius of curvature R2 of the spherical lower front part is defined as R1>R2, the lower front part of the eyepiece comes close to the face of a user, and the height of the eyepiece decreases.

In accordance with a preferred aspect of the present invention, each upper side part of the eyepiece exhibits a spherical surface whose radius of curvature is R3, relation between R3 and R1 is defined as R3>R1, and each lower side part of the eyepiece exhibits a free curved surface.

When relation between radius of curvature R3 of each spherical upper side part of the eyepiece and radius of curvature R1 of the spherical upper front part of the eyepiece is defined as R3>R1, breadth of the eyepiece can be decreased. When each lower side part of the eyepiece forms a free curved surface, it can smoothly connect to adjacent spherical surfaces.

### BRIEF DESCRIPTION OF THE DRAWINGS

FIG. 1 is a front view of a full face piece of a breathing apparatus in accordance with a preferred embodiment of the present invention.

FIG. 2 is a side view of a full face piece of a breathing apparatus in accordance with a preferred embodiment of the present invention.

FIG. 3 is a perspective view of a full face piece of a breathing apparatus in accordance with a preferred embodiment of the present invention.

FIG. 4 is a front view of an eyepiece of a full face piece of a breathing apparatus in accordance with a preferred embodiment of the present invention.

FIG. 5 is a side view of an eyepiece of a full face piece of a breathing apparatus in accordance with a preferred embodiment of the present invention.

FIG. 6 is a perspective view of an eyepiece of a full face piece of a breathing apparatus in accordance with a preferred embodiment of the present invention.

### MODES FOR CARRYING OUT THE INVENTION

A full face piece of a breathing apparatus in accordance with a preferred embodiment of the present invention will be described.

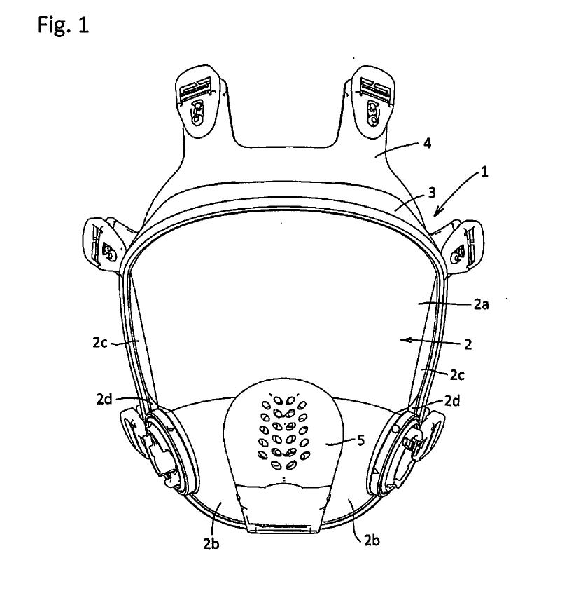

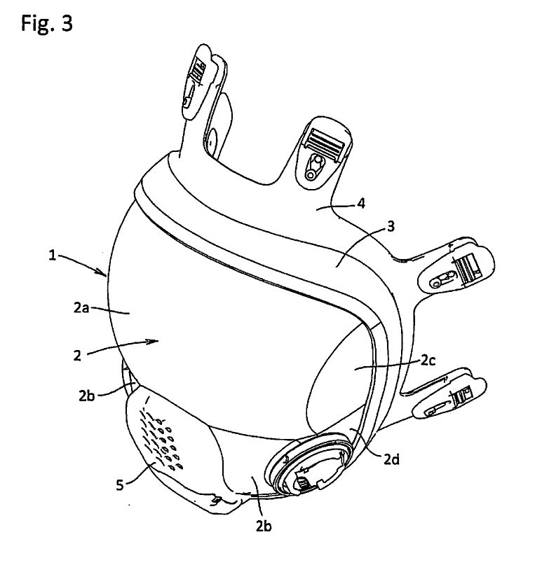

As shown in FIGS. 1 to 3, a full face piece 1 of a breathing apparatus comprises a single eyepiece 2 for covering a front part and both side parts of a face of a user of the breathing apparatus. The eyepiece 2 is made of transparent hard plastic material. The full face piece 1 further comprises a main body 3 integrally united with a circumference of the eyepiece 2 so as to cover a circumferential part of the face of the user. The main body 3 is made of flexible elastic material. The full face piece 1 further comprises fastening band connections 4 integrally formed with the main body 3. The fastening band connections 4 are connected to fastening bands for attaching the full face piece 1 to the head of the user. The fastening bands are not shown in FIGS. 1 to 3.

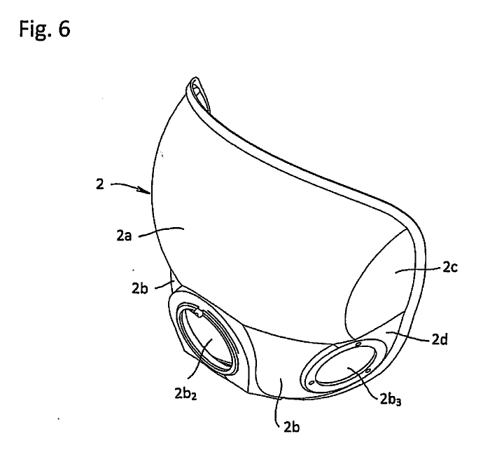

As shown in FIGS. 1 to 6, an upper front part 2a, a lower front part 2b and both upper side parts 2c of the eyepiece 2 exhibit spherical surfaces independent of one another. Relation among radius of curvature R1 of the spherical upper front part, radius of curvature R2 of the spherical lower front part and radius of curvature R3 of each spherical upper side part is defined as R3>R1>R2. Each lower side part 2d of the eyepiece 2 exhibits a free curved surface.

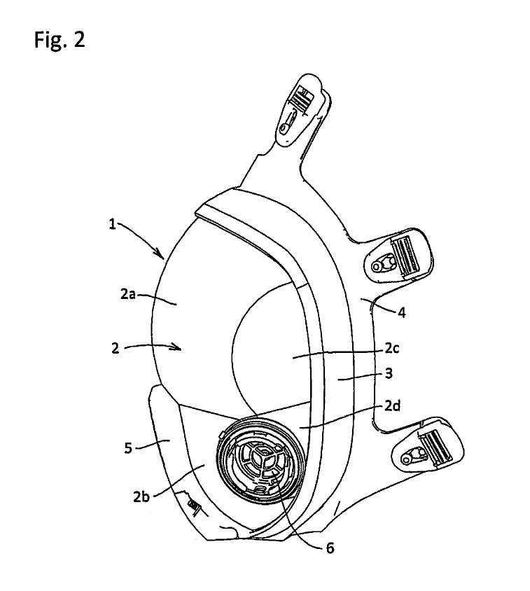

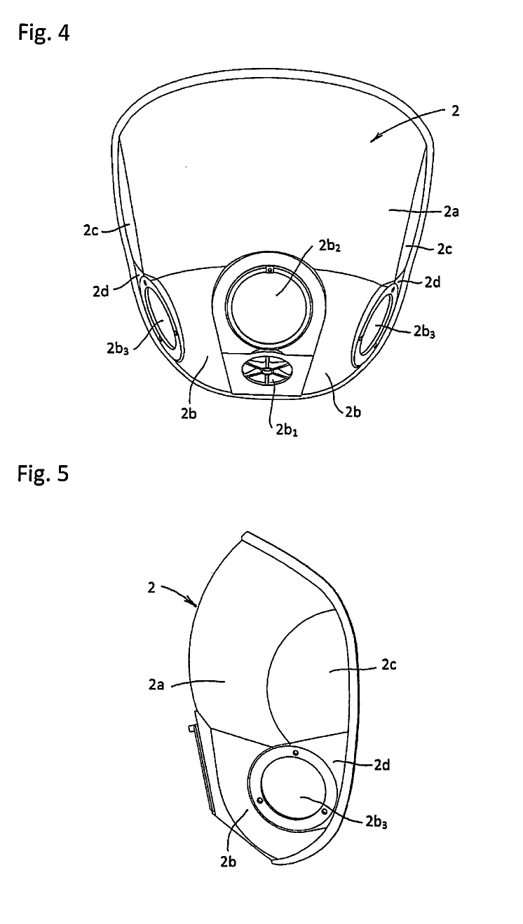

As shown in FIGS. 4 to 6, the eyepiece 2 is provided with an exhale valve accommodation hole 2b1 and a voice conductor accommodation hole 2b2 at a center part of the lower front part 2b, and an inhale valve accommodation hole 2b₃ at each side part of the lower front part 2b. An exhale valve, which is not shown in the Figures, is attached to the exhale valve accommodation hole 2b1 and a voice conductor, which is not shown in the Figures, is attached to the voice conductor accommodation hole 2b2. As shown in FIGS. 1 to 3, a protection cover 5 is attached to the eyepiece 2 so as to cover the exhale valve and the voice conductor. As shown in FIG. 2, an inhale valve 6 is attached to each inhale valve accommodation hole 2b₃. Moreover, a dust removing filter or an absorbing can, which is not shown in the Figures, is attached to the inhale valve accommodation hole 2b₃.

As can be seen from FIGS. 4 to 6, the exhale valve accommodation hole 2b₁ and the voice conductor accommodation hole 2b₂ are provided with an elevated edge similar in appearance to a battery so as to facilitate attaching of the protection cover 5. Also, the inhale valve accommodation holes 2b₃ are provided with elevated edges similar in appearance to batteries so as to facilitate attaching of the dust removing filters or the absorbing cans. Tops of the elevated edges are made flat. As can be seen from FIG. 4, the lower front part 2b of the eyepiece 2 is divided into a left half part and a right half part by the elevated edge for facilitating the attachment of the protection cover 5. However the left half part and the right half part cooperate to exhibit a single spherical surface.

In the full face piece 1, the eyepiece 2 comprises a spherical surface. Therefore, man-hours required to manufacture a metal mold for manufacturing the eyepiece are fewer than in the case of the conventional full face piece wherein the eyepiece generally exhibits a complicated curved surface.

When the whole body of the eyepiece 2 exhibits a single spherical surface, decrease of man-hours required to manufacture a metal mold for manufacturing the eyepiece becomes maximum. However, height, breadth and depth of the eyepiece 2 become large and the full face piece 1 or the breathing apparatus comprising the full face piece 1 becomes inconvenient.

In the full face piece 1, the upper front part 2a and the lower front part 2b of the eyepiece 2 exhibit spherical surfaces independent of each other. Therefore, depth of the eyepiece 2 becomes less than that of an eyepiece whose upper front part and lower front part exhibit a single spherical surface. Relation between radius of curvature R1 of the spherical upper front part 2a and radius of curvature R2 of the spherical lower front part 2b is defined as R1>R2. Thus, the lower front part 2b of the eyepiece 2 comes close to the face of a user, and the height of the eyepiece 2 decreases.

In the full face piece 1, each upper side part 2c of the eyepiece 2 exhibits a spherical surface whose radius of curvature is R3 and relation between R3 and R1 is defined as R3>R1. Thus, breadth of the eyepiece 2 decreases.

By means of the aforesaid specific features, the full face piece 1 becomes appropriate in size and convenient to use.

In the full face piece 1, each lower side part 2d of the eyepiece 2 forms a free curved surface. Thus, the lower side part 2d of the eyepiece 2 can smoothly connect to the adjacent upper front part 2a, lower front part 2b and upper side part 2c which exhibit spherical surfaces.

The spherical surfaces imparted to the eyepiece 2 are not restricted to those described above. For example, the front part, both upper side parts and both lower side parts can be given spherical surfaces independent of one another and both middle side parts can exhibit free curved surfaces.

Kind, number and purpose of the holes formed in the eyepiece 2 are not restricted to those described above. The present invention can be applied to a full face piece provided with no hole.

The present invention can be widely used for a full face piece of a breathing apparatus comprising an eyepiece for covering a front part and both side parts of a face and a main body integrally united with circumference of the eyepiece so as to cover a circumferential part of the face, wherein the eyepiece is made of transparent hard plastic material and the main body is made of flexible elastic material.

### EXPLANATION OF REFERENCE SIGNS

1 Full face piece
2 Eyepiece
2a Upper front part
2b Lower front part
2b₁ Exhale valve accommodation hole
2b₂ Voice conductor accommodation hole
2b₃ Inhale valve accommodation hole
2c Upper side part
2d Lower side part
3 Main body
4 Fastening band connection
5 Protection cover
6 Inhale valve

1. A full face piece of a breathing apparatus comprising an eyepiece for covering a front part and both side parts of a face and a main body integrally united with a circumference of the eyepiece so as to cover a circumferential part of the face, wherein the eyepiece is made of transparent hard plastic material and the main body is made of flexible elastic material, and wherein the eyepiece comprises a plurality of spherical surfaces.

2. A full face piece of a breathing apparatus of claim 1, wherein an upper front part and a lower front part of the eyepiece exhibit spherical surfaces independent of each other, and wherein relation between radius of curvature R1 of the upper front part and radius of curvature R2 of the lower front part is defined as R1>R2.

3. A full face piece of a breathing apparatus of claim 2, wherein each upper side part of the eyepiece exhibits a spherical surface whose radius of curvature is R3, wherein relation between R3 and R1 is defined as R3>R1, and wherein each lower side part of the eyepiece exhibits a free curved surface.
